(19) United States
(12) Patent Application Publication
(10) Pub. No.: US 2016/0350725 A1
(43) Pub. Date: Dec. 1, 2016

(54) IDENTIFYING PRODUCTS FOR SERVICING

(71) Applicant: NCR Corporation, Duluth, GA (US)

(72) Inventor: Gardiner Arthur, Dundee (GB)

(21) Appl. No.: 14/725,774

(22) Filed: May 29, 2015

(51) Int. Cl. G06Q 10/00; G06Q 20/18

(52) U.S. Cl. CPC G06Q 10/20; G06Q 20/18

(57) ABSTRACT

Disclosed herein are methods and systems for identifying a product for servicing. The systems and methods can include receiving fault data and workload data for a product. Once the fault data and workload data are received, a fault rate for the product can be determined based upon the fault data and the workload data. Finally, a determination as to when the product may be identified for servicing can be made based on the fault rate.

### BACKGROUND

Self-service terminals have become ubiquitous within the retail and banking environments. At the retail level, self-service terminals reduce labor requirements and increase check-out efficiency by allowing one cashier to oversee four check-out lanes. Within the financial services sector, self-service terminals, or automated teller machines, allow banking and other financial customers to make withdrawals and deposits or perform other financial transactions without having to find time to visit a financial institution during banker's hours or even visit a financial institution.

### SUMMARY

Disclosed herein are methods and systems for identifying a product for servicing. The systems and methods can include receiving fault data and workload data for a product. Once the fault data and workload data are received, a fault rate for the product can be determined based upon the fault data and the workload data. Finally, a determination as to when the product may be identified for servicing can be made based on the fault rate.

### BRIEF DESCRIPTION OF THE FIGURES

FIG. 1 shows an example operating environment consistent with the disclosure;

FIG. 2 shows a schematic of an example self-service terminal;

FIG. 3 shows a schematic of an example computing device;

FIG. 4 shows a flowchart for an example method for identifying a product for servicing; and

FIG. 5 shows chart with example data.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

As SST use increases, servicing of SSTs also increases. Manufacturers and operators of SSTs can control the output of SSTs. For example, manufacturers can tell operators that a certain quality of currency should be installed in a given product or machine for the product or machine to operate correctly. For instance, a manufacturer of an automated teller machine (ATM) can tell a bank that currency, or notes, of a certain quality should be loaded into cassettes installed in the ATM. Otherwise, the ATM could experience an increased number of malfunctions, such as jams or dispensing too little or too many notes. In response to the manufacturers' recommendations, the operators can load cassettes with a certain quality of banknotes.

One area where both manufacturers and operators can lose quality control is the input from a customer. Both the manufacturers and operators can display warnings and suggestions as to what is and is not acceptable as an input, but customers can easily overestimate the quality of inputs or simply ignore the display altogether. For example, a manufacturer of an ATM or other SST can post a warning, which a customer can acknowledge via keypad inputs, that currency with rips, tears, that is taped or stapled together, etc. is not an acceptable input for deposit. Customers can ignore the message and attempt to deposit currency or checks that have rips, tears, and that is taped and stapled together.

As disclosed herein, with the increase usage of SSTs, systems and methods can be used to determine when a SST is experiencing routine, or expected, problems or is having chronic problems that could be addressed via routine servicing or specific servicing that could target a chronic problem. Depending upon the type of problem, or fault, a product or machine is experiencing, differing levels of service can be performed.

For instance, the performance of products and devices, for example, media handling devices such as SSTs, can be affected by many different aspects including, but not limited to, the physical condition of the device, the quality of the media handled by the device, and the external environment.

Basic servicing, sometimes referred to as first line servicing, of devices, can be performed by less-skilled personnel. For example, simple tasks, such as clearing media jams, cleaning debris from the device, and testing the device to ensure that correct operation, can be performed by less skilled technicians. Second line servicing, may utilize skilled resources that can perform an in-depth analysis of device performance in order to make a determination as to whether the device is capable to operate at a particular standard of performance, and if not, take appropriate service actions to possibly raise the level of performance. For example, a second line service technician could possibly change parts with updated replacement parts to increase a device's performance.

The ability to determine which type of service action could be performed based on a fault event can help ensure that the servicing of the devices in an installed base of products works to improve efficiencies in servicing the products.

The systems and methods disclosed herein combine fault data with workload data, to create a statistical model of the device performance in an installed base (i.e., devices or devices of a similar class, operating in a similar location and a similar environment, etc.) of products. The statistical model may allow for a comparison of the performance of individual devices, or components within devices, with the collective performance of the installed base of devices, or components within devices, to identify devices, or components within devices. Thus allowing skilled resources to be assigned to perform detailed second line service actions to achieve an increased performance level for the device, or components within devices, and the economical servicing of the installed base.

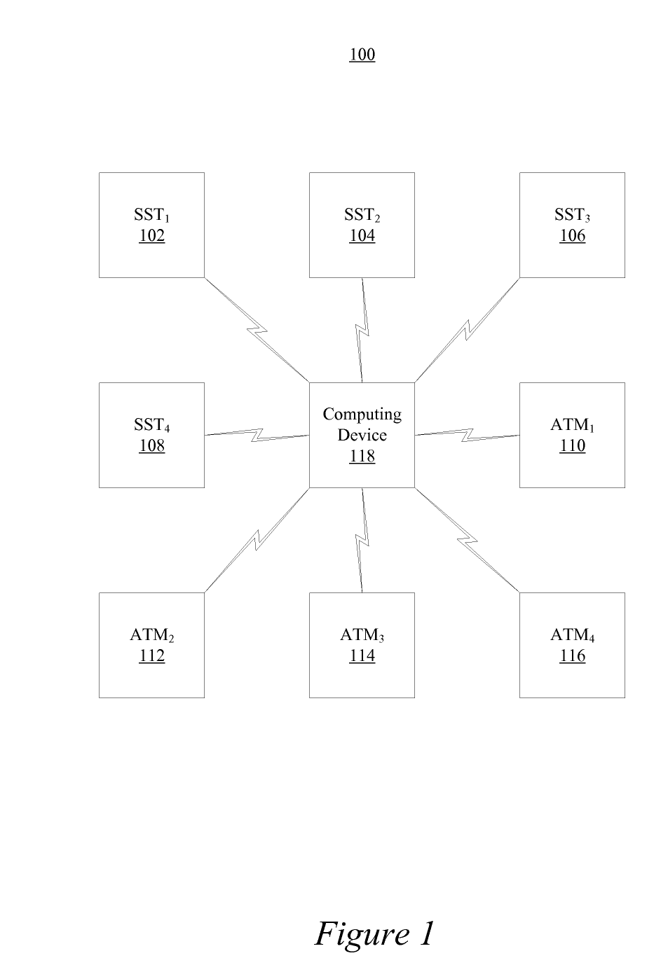

FIG. 1 shows an example schematic of an operating environment for a plurality of SSTs. The plurality of SSTs can include SST₁ 102, SST₂ 104, SST₃ 106, and SST₄ 108. Examples of an SST can include, but are not limited to, a self-service checkout register found at a point of sale (POS) location, an ATM, a self-service kiosk used at POS location or used to provide information to a person, a vending machine, etc. Thus, the plurality of SSTs shown in FIG. 1 can also include, but is not limited to, ATM₁ 110, ATM₂ 112, ATM₃ 114, and ATM₄ 116.

The plurality of SSTs can be connected to a computing device 118. Non-limiting examples of computing device 118 include a central server, a bank mainframe computer, etc. The plurality of SSTs can be connected to computing device 118 via a variety of connection methods including, but not limited to, an Ethernet connection, a connections using a plain old telephone system (POTS) line, via the Internet, interbank networks such as BancNet, an ISO 8583 messaging system, etc. The connection can be secured via a variety of methods including, but not limited to a secure socket layer (SSL) encryption, by use of a virtual private network (VPN) connection, etc.

As is described herein, the plurality of SSTs can experience a workload. Non-limiting examples of a workload can include, a number of currency notes dispensed, a number of currency notes accepted, a number of checks accepted, a number of cards read, a number of receipts printed, a number of financial transactions completed, a number of items scanned, a number of items weighed, etc. The SST can track the workload and transmit the information as workload data to computing device 118 as described herein.

In addition, and as described herein, the plurality of SSTs can include any number of sensors and other devices that can detect a fault. Non-limiting examples of a fault include, a jam in a currency dispenser, a jam in a currency accepter, a failure to read a card (e.g., an ATM card, a debit card, a credit card, or a gift card), failure to print a receipt, a jam in a receipt printer, an error associated with a keypad, etc. The SSTs can record the number of faults as fault data that can be transmitted to computing device 118 as described herein.

As is described herein, computing device 118 can use the workload data and the fault data to determine a fault rate for each of the plurality of SSTs. The fault rates for the plurality of SSTs can be used to determine when a machine may be serviced to resolve chronic issues, and perhaps even a type of service that may be performed to address a fault. For example, a ratio of workload to number of faults for each of the plurality of SSTs can be used to determine a fault rate for each of the plurality of SSTs. Based on the plurality of fault rates, a particular product or machine can be identified as a service candidate. The service to resolve the fault(s) can be routine service or maintenance or service in addition to routine maintenance or service. For instance, SST₄ 108 can include a currency accepter and may have a fault rate for the currency accepter that indicates applicable service for the currency accepter. ATM₂ 112 may have a receipt printer and the fault rate for the receipt printer may indicate service that will be handled during upcoming routine maintenance or servicing of ATM₂ 112.

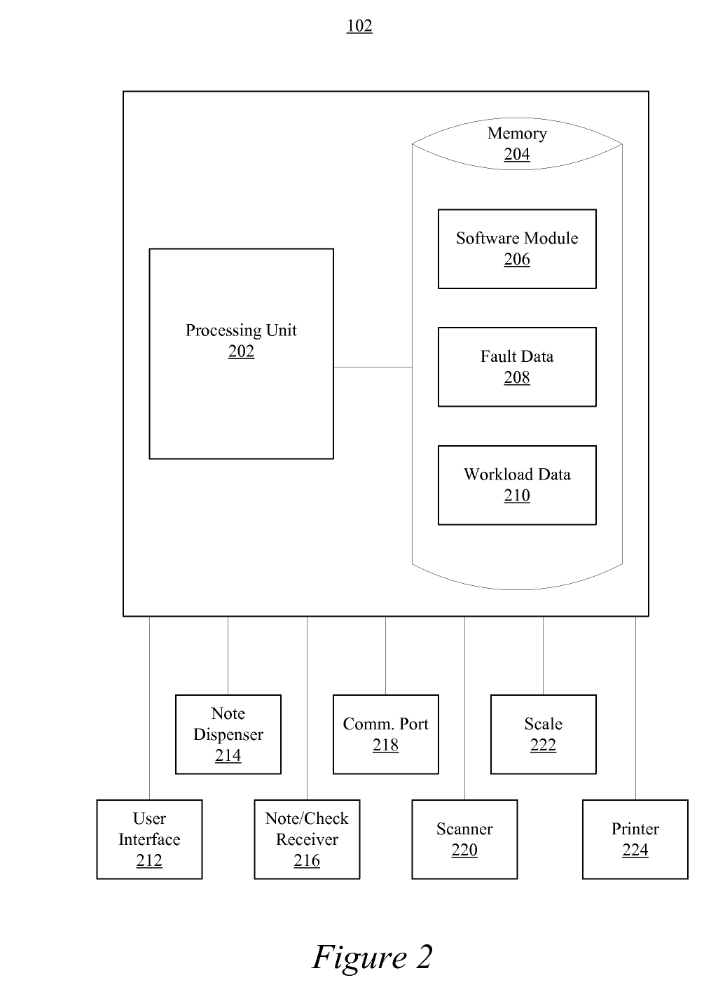

FIG. 2 shows a schematic of an example SST, for instance, SST₁ 102. As shown in FIG. 2, an SST may include a processing unit 202 and a memory unit 204. Memory unit 204 may include a software module 206, fault data 208, and workload data 210. The fault data 208 can include a plurality of fault data. The workload data can include a plurality of workload data. The fault data and workload data can be stored in one or more data files. The SST also can include a user interface 212, a note dispenser 214, a note/check receiver 216, a communication port 218, a scanner 220, a scale 222, and a printer 224. Devices within the SST can be combined. For example, note dispenser 214 and note/check receiver 216 may be one unit that performs both operations.

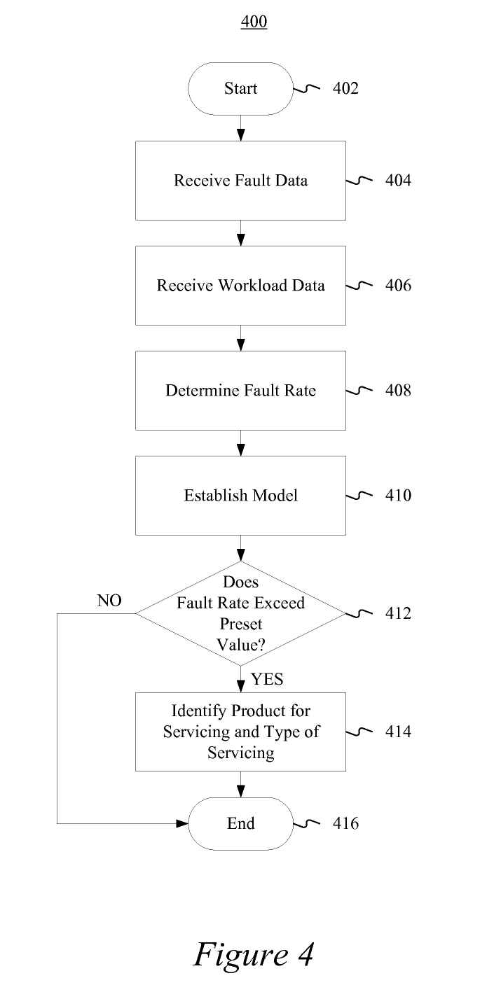

The fault data and workload data can be received from any device operatively connected to the processing unit 202. For example, fault data and workload can be received from note dispenser 214, scanner 220, printer 224, etc. While executing on processing unit 202, software module 206 may perform processes for identifying a product for service, including, for example, one or more stages included in method 400 described below with respect to FIG. 4.

User interface 212 can include any number of devices that allow a user to interface with an SST. Non-limiting examples of user interface 212 include a keypad, a microphone, a speaker, a display (touchscreen or otherwise), a card reader, etc. Note dispenser 214 can allow the SST to dispense currency to a customer. Non-limiting examples of note dispenser 214 include a banknote dispenser and a coin dispenser. Note/check receiver 216 can allow for the SST to receive notes, checks, credit/debit/gift card information, as well as coins from a user. Non-limiting examples of note/check receiver 216 include a banknote and coin receiver and a card reader to read credit/debit/gift cards. Communication port 218 can allow the SST to communicate with computing device 118 as described herein.

Scanner 220 can allow SST₁ 102 to receive information. For example, scanner 220 can allow SST₁ 102 to receive information by allowing a customer to scan merchandise UPC codes, coupons, QR codes, etc. Scale 222 can allow SST₁ 102 to receive weight information. For example, SST₁ 102 can be a self-checkout register at a store and scale 222 can allow a customer to weigh product or other items sold by weight. In addition, scale 222 can allow SST₁ 102 to verify information received. For instance, scale 220 can be incorporated into a bagging area of a self-service checkout register. After an item is scanned using scanner 220, processing unit 202 can access product information (e.g., the item's weight) stored in memory 204 about the item. When the customer places the item in the bagging area, scale 222 can verify that the item scanned weighs approximately the amount as the item placed in the bagging area. The comparing of weight data can help to minimize shrink within a retail environment. For example, SST₁ 102 can notify an attendant that a different item was bagged than the item scanned. For instance, by comparing weight data SST₁ 102 can notify an attendant if a consumer scans a hammer and bags a chainsaw, which relatively speaking, is more expensive and heavier than a hammer. Printer 224 can allow SST₁ 102 to print a receipt for a transaction or print coupons after a transaction is complete.

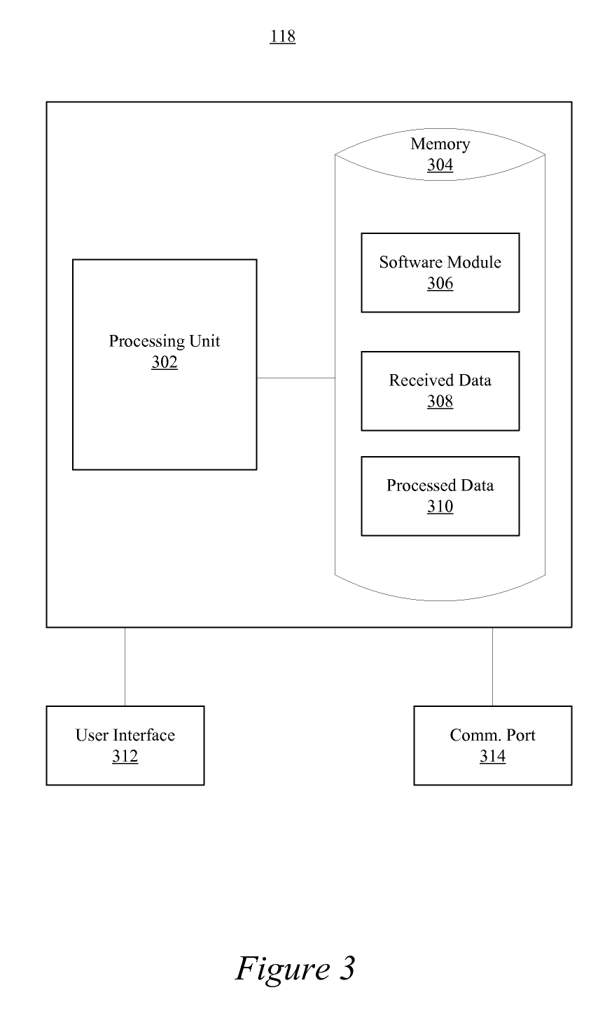

FIG. 3 shows an example schematic of computing device 118. As shown in FIG. 3, computing device 118 can include a processing unit 302 and a memory unit 304. Memory unit 304 can include a software module 306, received data 308, and processed data 310. Received data 308 and processed data 310 can include a single data file or a plurality of data files. Computing device 118 can include a user interface 312 and a communication port 314.

User interface 312 can include any number of devices that allow a user to interface with computing device 118. Non-limiting examples of user interface 312 include a keypad, a microphone, a speaker, a display (touchscreen or otherwise), etc. Communication port 314 can allow computing device 118 to communicate with the plurality of SSTs as described herein. While executing on processing unit 302, software module 304 may perform processes identifying a product for service, including, for example, one or more stages included in method 400 described below with respect to FIG. 4.

Computing device 118 may be implemented using a personal computer, a network computer, a mainframe, or other similar microcomputer-based workstation. Computing device 118 may be located in close proximity to the plurality of SSTs or may be may be in a remote location. For instance, in banking or retail environment, computing device 118 may include a computer located at a central location (e.g., a bank's headquarters or a stores headquarters) and receive data from different locations throughout a region or the world. In addition, computing device 118 can be located at a store or bank and receive data only from SSTs at the store or bank.

Computing device 118 can include any computer operating environment, such as hand-held devices, multiprocessor systems, microprocessor-based or programmable sender electronic devices, minicomputers, mainframe computers, and the like. Computing device 118 can also be practiced in distributed computing environments where tasks are performed by remote processing devices. Furthermore, computing device 118 can include a mobile terminal, such as a smart phone, a cellular telephone, a portable computer, a hand held computer, etc. The aforementioned systems and devices are examples and computing device 118 can include other systems, devices, and combinations thereof.

FIG. 4 is a flow chart setting forth the general stages involved in a method 400 for identifying devices for service. Method 400 may be implemented using, for example, computing device 118 or any of a plurality of SSTs (e.g., SST₁ 102) as described in more detail herein.

Method 400 can begin at starting block 402 and proceed to stage 404 where the computing device 118 can receive fault data. The fault data can be received from one or more SSTs. The SSTs can be similar or different. For instance, the fault data received by the computing device 118 can be from a self-service checkout register and an ATM. The fault data can also be for machines owned by different entities. For example, some of the fault data may be from self-service checkout registers owned (or leased) and operated by a retailer or retailers and some of the fault data may be from ATMs owned (or leased) by a bank or banks. The fault data may be for a particular geographic location or region. For example, the fault data may be for a SSTs located at an amusement park or sporting venue. The fault data could also be for SSTs located in Atlanta, the State of Georgia, the Southeast region of the United States, or Eastern Europe.

The fault data can be for specific components of SSTs. For example, a particular model self-checkout register and a particular model ATM may have the same model currency dispenser and currency accepter. The fault data could therefore be from different types of SSTs, but for the same component or components (e.g., the currency dispenser and currency accepter).

The fault data can be recorded by sensors in the SSTs. The fault data can be course or fine for a given SST. Course fault data can include a high level overview of a fault with little details about the fault. Fine fault data can include details as to what component of a SST malfunctioned and what conditions may have caused the fault. For example, at one extreme, fault data can include a SST simply recording that the SST experienced a fault with no indication of what component malfunctioned or what may have caused the malfunction. In other words, the only information recorded is that there was a fault. At another extreme, fault data can include exactly which component, components, or subcomponent or subcomponents of a component experienced a fault and information as to what may have triggered the fault. In other words, the SST can record what component of the SST (and subcomponent of the component) experienced a fault and what events occurred immediately prior to and after the fault occurred that may have triggered the fault.

In an example, SST₁ 102 can be a self-checkout register at a store. SST₁ 102 can include note/check receiver 216, note dispenser 214, printer 224, and scanner 220. During operation any or all of the components of SST₁ 102 could experience a fault or multiple faults during a transaction. For example, note/check receiver 216 may not accept a customer's banknote or may incorrectly recognize the banknote (e.g., accept the note as a $5.00 bill when the note was actually a $20.00). In addition, note dispenser 214 may jam when dispensing the customer's change. Each of these faults can be recorded by SST₁ 102, along with actions that may have triggered the fault, as fault data 208. For instance, SST₁ 102 may record that during the dispensing of the customer's change, the customer pulled on the note before the note was completely dispensed causing note dispenser 214 to jam. The details recorded as fault data can include that the note dispenser 214 experienced a malfunction. Finer details can be recorded as well. For example, SST₁ 102 can record that a gear within note dispenser 214 broke due to the excessive strain placed on the gear as the customer attempted to pull the note from note dispenser 214 too soon. In addition, SST₁ 102 may record that the customer tried to insert two notes into note/check receiver 216 at one time, which caused note/check receiver 216 to jam.

In another example, ATM₁ 110 may simply record a fault and no other information about the fault. For example, ATM₁ 110 can experience a fault, such a jam within a currency dispenser. ATM₁ 110 record that the fault occurred, but not record what component (e.g., the currency dispenser) is the cause of the fault.

Other examples of faults include, but are not limited to, components failing a self-diagnostic test, a SST experience a power failure or power surge, attempted tampering with a SST or components of the SST, etc. For example, a thief can attempt to break into an ATM by hitting it with a hammer. The shock from the hammer strike can cause the ATM to shutdown as a measure to protect currency inside the ATM. The ATM can record the shutdown as a fault, along with the reason for the shutdown (e.g., an accelerometer indicated the shock from the hammer) as fault. Other examples of tampering that may trigger a fault include a criminal attempting to place a skimmer on a card reader or false keypad on the SST.

The fault data collected by the plurality of SSTs can be received by computing device 118 at the time of a fault, at regularly scheduled intervals, or on demand. For example, a fault that could indicate tampering with the SST (e.g., somebody trying to break into the SST), the fault could be sent to computing device 118 immediately. In another example, the SST may record faults throughout a time period (e.g., 24 hours, 1 week, etc.) and transmit the fault data to computing device 118 at the end of the time period. In yet another example, a technician can submit a request, via user interface 312 at computing device 118, for the SST to transmit fault data to computing device 118. In yet another example, the technician can cause the SST, via user interface 212 at SST₁ 102, to transmit fault data to computing device 118.

From stage 404 where the fault data is received, method 400 can proceed to stage 406 where computing device 118 can receive workload data. The workload data can be received from one or more SSTs. The SSTs can be similar or different. For instance, the workload data received by computing device 118 can be from a self-service checkout register and an ATM. The workload data can also be for machines owned by different entities. For example, some of the workload data may be from self-service checkout registers owned (or leased) and operated by a retailer or retailers and some of the workload data may be from ATMs owned (or leased) by a bank or banks. The workload data may be for a particular geographic location or region. For example, the workload data may be for a SSTs located at an amusement park or sporting venue. The workload data could also be for products or machines located in Atlanta, the State of Georgia, the Southeast region of the United States, or Eastern Europe.

The workload data can be for specific components of SSTs. For example, a particular model self-checkout register and a particular model ATM may have the same model currency dispenser and currency accepter. The workload data could therefore be from different types of SSTs, but for the same component or components.

The workload data can be recorded by sensors in the SSTs. The workload data can be course or fine for a given SST. Course workload data can include a high level overview of workload with little details about the workload. Fine workload data can include details as to what components of a SST are performing work and under what conditions the work is occurring. For example, at one extreme, workload data can include a SST simply recording that the SST performed work with no indication of what component or components performed the work. At another extreme, workload data can include exactly which component, components, or subcomponent or subcomponents of a component performed work and information as to how much work they performed. In other words, the SST can record what component of the SST (and subcomponent of the component) performed work and details of the work performed by the component, components, and subcomponents.

In an example, SST₁ 102 can be a self-checkout register at a store. When a customer checks out, SST₁ 102 can record what keys on user interface 212 were pressed and with what force they were pressed, how many notes were received by note/check receiver 216, the orientation, condition, and serial number of the notes received, how many notes were dispensed by note dispenser 214, the orientation, condition, and serial number of the notes dispense, how many linear inches of paper were used by printer 224 in printing a receipt, how much weight was placed on scale 222 by each item weighed as well as the total weight of all items weighed, and how many items were scanned using scanner 220. For instance, note/check receiver 216 may receive three $20.00 bills from a customer. In addition, note dispenser 214 may dispense four $1.00 bills, three quarters, one dime, and four pennies. Scanner 220 may record that two items were scanned and scale 222 may record that the total weight of the two items scanned and placed in a bagging area weighed 2.5 pounds. Each of these notes received, notes dispensed, items scanned, items weighed, etc. can be recorded as work to create workload data.

In another example, ATM₁ 110 may simply record that a financial transaction occurred and no other information about the financial transaction. For instance, ATM₁ 110 can dispense currency and the workload would be counted as one dispensing of currency without regard to the number of notes ATM₁ 110 dispensed. Regardless of if one note was dispensed or 15 notes were dispensed, ATM₁ 110 records that one work event occurred.

The workload data collected by the plurality of SSTs can be received by computing device 118 at the time of work is performed, at regularly scheduled intervals, or on demand. For example, a customer could make a purchase using a SST and workload could be sent to computing device 118 immediately. In another example, the SST may record workload throughout a time period (e.g., 24 hours, 1 week, etc.) and transmit the workload data to computing device 118 at the end of the time period. In yet another example, a technician can submit a request, via user interface 312 at computing device 118, for the SST to transmit workload data to computing device 118. In yet another example, the technician can cause the SST, via user interface 212 at SST₁ 102, to transmit workload data to computing device 118.

From stage 406 where workload data is received, method 400 can proceed to stage 408 where a fault rate can be determined. The fault rate can be determined in a variety of fashions. As an example, the fault rate can be determined by comparing the number of faults to the workload. For instance, a number of faults occurring within an ATM can be compared to the number of transactions the ATM performs.

Just as with the workload data and the fault data, the fault rate can be course or fine. For example, for an ATM that records workload as a single event (i.e., money was dispensed) and faults as a single event (i.e., something went wrong without any other detail), a course fault rate can be determined. For instance, during the course of a year, an ATM may record a workload that indicates 12,000 transactions occurred and during the year 100 faults occurred. The resulting fault rate might be 0.083 faults per transaction.

In another example an ATM may record that 12,000 transactions occurred and in the course of these transactions, 20,000 notes were dispensed via a currency dispenser and 3,000 notes were accepted via a currency accepter. Each note dispensed or accepted could be counted as a work event. During the course of these transactions the currency dispenser could have experienced 200 faults and the currency accepter could have experienced 150 faults. In other words, the ATM had a total workload of 23,000 work events and 350 total faults. The fault rate for the ATM can include multiple components. For example, an overall fault rate can be determined, a fault rate for the currency dispenser can be determined, and a fault rate for the currency accepter can be determined. In this example the overall fault rate may be 0.015 faults per work event, the fault rate for the currency dispenser may be 0.01 faults per notes dispensed, and the fault rate for the currency accepter may be 0.05 faults per notes accepted. In this example, the fault rate for the currency accepter is five times that of the currency dispenser.

As illustrated the fault rate can be as detailed as the data collected by a SST. If a SST collects detailed data about workload such as workload per component and fault data such as a number of faults per component, a detailed fault rate can be determined. If a SST only collects course data such as a number of transactions and a number of faults, then a course fault rate can be determined.

From stage 408 where a fault rate is determined, method 400 can proceed to stage 410 where a model can be established. The model established can be a statistical model or other forms of relationship that can allow for device comparison. Models can be established for devices as a whole, for components of a device, subcomponents of a component, etc. For example, and as discussed herein, the model can be based on averages, simple ordering of data in ascending or descending order, etc. and cover an entire class of SSTs and components of the SSTs.

From stage 410 where a model is established, method 400 can proceed to decision block 412 where a determination can be made as to whether the fault rate exceeds a preset value. In other words, the fault rate of a product can be compared against the model to determine a type of service (e.g., first line or second line service) that can be performed. The preset value can be any number of values and can be determined based on the model. For example, the preset value can be an average of all SSTs of the same make and model. For instance, the fault rates for 10,000 ATMs that are the same make and model can be determined and averaged. This average or the average plus x number of standard deviations can be the preset values. The various fault rates for the 10,000 ATMs can be sorted in descending order and the top 1% of the ATMs (i.e., the top 100 ATMs) with the highest fault rates could be considered to exceed the preset value. In other words, the fault rate of the 101^{st} ATM is the preset value. In another example, the preset value can be a preset fault rate set by a manufacturer for quality control purposes. For example, a manufacturer might set the fault rate at 0.01 faults per work event.

When multiple fault rates for a single SST are calculated, multiple preset values can be used. For example, for an ATM, there could be an overall preset value, a preset value for the currency dispenser, a preset value for the currency accepter, a preset value for the keypad, etc. In addition, the preset value can be determined on a product by product basis. In other words, the fault rates for the various components of a machine can be compared with overall fault rate for the machine. For instance, in the example above, the overall fault rate is 0.015 faults per work event, the fault rate for the currency dispenser is 0.01 faults per notes dispensed, and the fault rate for the currency accepter is 0.05 faults per notes accepted. In this non-limiting example, the preset value could be the overall fault rate (0.015). Therefore the currency dispenser would not have a fault rate that exceeds the preset value, but the currency accepter would have a fault rate that would exceed to preset value.

When the fault rate exceeds the preset value, method 400 can proceed from decision block 412 to stage 414 where a product can be identified for servicing along and a type of servicing can be identified. If a particular product or machine (e.g., a SST) from a plurality of products or machines (e.g., SSTs) has a fault rate that exceeds the preset value the particular product can be identified for servicing. A particular SST or component of a SST can be identified for service along with a type of service. In other words, if the fault rate for a particular SST or component of a SST deviates from the established model then the SST or component of the SST can be targeted for service and a type of service (e.g., first line or second line) can be identified.

For example, if the overall fault rate is above the preset value the SST can be identified for service along with a type of service. In addition, various components of a SST can be identified for service and level of service. For instance, in the example above, the currency accepter has a fault rated of 0.05 and the overall fault rate is 0.015. If the overall fault rate is the preset value, then the currency accepter could be identified for servicing and for a second line service due to the high fault rate for the currency accepter. In other words, because the fault rate of the currency accepter is about 3.3 times that of the overall fault rate of the ATM, the currency accepter could be identified and targeted for service at a higher level than the currency dispenser and other components. In this instance, a first line technician can visit the ATM and perform routine service and a second line technician can visit the ATM and can focus on chronic issues with the currency accepter instead of spending extra time examining the currency dispenser or other components of the ATM.

From stage 414 where the product is identified for servicing along with a type of service, method 400 can proceed to termination block 416. In addition, method 400 can proceed from decision block 412 to termination block 416 if the fault rate does not exceed to preset value.

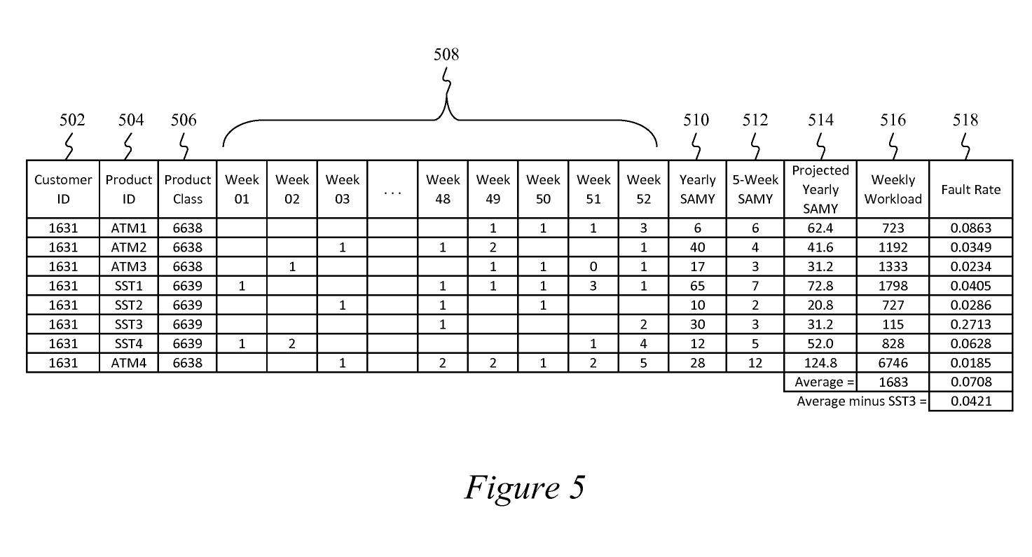

FIG. 5 shows example data and will be described in context with at least FIGS. 1 and 4. The data can include any number of items. For example, data 500 can include a customer ID 502, a product ID 504, a product class 506, faults occurring in a given week 508, a yearly total of service actions per machine (SAMY) 510, a 5-week SAMY 512, a projected yearly SAMY 514, and a weekly workload 516, and a fault rate 518. Data 500 can be received at computing device 118 in its entirety or portions of data 500 can be received at computing device 118 and other portions of data 500 can be determined by computing device 118.

For example, each of the plurality of SSTs shown in FIG. 1 can record its own customer ID 502, product ID 504, product class 506, faults occurring in a given week 508 and weekly workload 516. This data can be sent to computing device 118 from each of the plurality of SSTs. Once computing device 118 receives the data, computing device 118 can determine yearly SAMY 510, 5-week SAMY 512, projected yearly SAMY 514, and the fault rate 518 for each of the plurality of SSTs.

In another example, each of the SSTs can record its own customer ID 502, product ID 504, product class 506, faults occurring in a given week 508 and weekly workload 516. Each of the SSTs can determine yearly SAMY 510, 5-week SAMY 512, projected yearly SAMY 514, and the fault rate 518 for itself. Once each SST has determined its yearly SAMY 510, 5-week SAMY 512, projected yearly SAMY 514, and the fault rate 518, each of the SSTs can send its corresponding data to computing device 118.

Data 500 can be used in a variety of fashions. For example, the faults occurring in a given week 508 can show spikes in faults for given time periods. For instance ATM₁ 110 may be located in a mall and show a spike in faults in the weeks between Thanksgiving and Christmas. SST₁ 102 may be a self-checkout register at a home improvement store and show a spike in faults during spring when people undertake a lot of home improvement projects.

5-week SAMY 512 is used for illustrative purposes only and a SAMY for any time period can be calculated. 5-week SAMY 512, or any n-week SAMY, can be used to show recent fault trends in an SST. For example, 5-week SAMY 512 may show that over the last five week a particular SST, ATM₁ 110 in this example, is having a lot of faults where in the previous 48 weeks it had no faults.

In the example shown in FIG. 5, the fault rate is determined using the 5-week SAMY 512 and the weekly workload 516. For instance, for ATM₁ 110 the fault rate of 0.0883 is determined by dividing the 5-week SAMY (6) by the weekly workload (723). The projected yearly SAMY is found by dividing the 5-week SAMY (6) by 5 and multiplying the result by 52. In other words, the projected yearly SAMY represents an expected number of faults for a year if the fault pattern of the last 5-weeks continues. The number of weeks for the 5-week SAMY can be any number of weeks, or an n-week SAMY. An n-week SAMY shorter than a year allows for recent trends (i.e., model generation) to be determined and eliminate biasing by high fault counts that may have been a result of a problem that was previously repaired. For example, during weeks 20-25 one of the SST may have had a high number of faults, but whatever was causing the faults could have been repaired in week 26. Thus, in order to avoid skewing data and identifying a product for servicing that has already been serviced, some data may be excluded. However, using ATM₂ 112 as an example, the 5-week SAMY (4) yields a projected yearly SAMY of 41.6, which is almost the same as the yearly SAMY (40) for ATM₂ 112. The conclusion drawn from the data for ATM₂ 112 could be that whatever is causing the faults has not been repaired and a second line technician may need to service the ATM₂ 112 to perform more in-depth analysis of ATM₂ 112.

Using the weekly workload and the fault rates can allow for greater insight into which SSTs can be targeted for repairs. For example, ATM₄ 116 appears to be a machine with chronic problems based solely on the 5-week SAMY (12) and the yearly projected SAMY (124.8). However, taking into account the weekly workload (6746 transactions) the fault rate (0.0185) can be determined. As shown, ATM₄ 116 may experience what looks like a lot of faults, but ATM₄ 116 is processing approximately 4 times the transactions as to other SSTs. When looking at just the fault rate for ATM₄ 116, ATM₄ 116 may appear as the best performing machine and may not be targeted or identified for servicing or elevated levels of servicing. In fact, elevated levels of servicing for ATM₄ 116 could lead to a decrease in performance due to good parts being replaced with defective parts.

Looking at the 5-week SAMY (3) and projected yearly SAMY (31.2) for SST₃ 106 may lead to a conclusion that SST₃ 106 is performing fine and not identified for service. However, as shown in FIG. 5, when the fault rate is examined, SST₃ 106 is clearly a poorly performing machine that could be targeted for servicing and elevated levels of servicing. In fact, the performance of SST₃ 106 is so poor that it raises the average fault rate for the plurality of SSTs and ATMs by 0.03 faults per transaction.

In addition, data 500 can show locations where more SSTs may be installed to lighten workload of existing SSTs. For example, ATM₄ 116 is handling a large number of transactions compared to the other products shown in FIGS. 1 and 5. Thus, a second or even third ATM could be positioned in proximity to ATM₄ 116 to decrease the workload of ATM₄ 116. The decrease in workload for ATM₄ 116 could lead to decreased wait time for customers wanting to use ATM₄ 116 and possible increased business for that location. For example, with a second or third ATM at the location of ATM₄ 116, the number of transactions handled between the two or three ATMs could increase (e.g., to 10,000 transactions) because customers, who would otherwise visit another location to use an ATM, instead of waiting to use ATM₄ 116, would not have to wait as long to use an ATM. The decreased workload on ATM₄ 116 could also lead to an increased life of ATM₄ 116 due to a decrease in wear and tear on ATM₄ 116.

As shown herein more than just a number of faults can be used to identify a product, machine, SST, ATM, etc. for servicing. Throughout this specification, terms such as product, machine, SST, and ATM may be used interchangeably to refer to items that can be identified for servicing. In addition, terms such as note, banknote, bill, currency, check, change, coin, coinage, etc. may be used interchangeably to refer to items a user may insert into a currency accepter or that may be dispensed by a currency dispenser.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, at a computing device comprising a processor, fault data and workload data for a product;
determining, by the computing device, a fault rate for the product based upon the fault data and the workload data; and
determining, by the computing device based on the fault rate, when the product needs servicing.

2. The method of claim 1, wherein the fault data includes a number of faults for a plurality of products.

3. The method of claim 1, wherein the fault data identifies a component of the product and a number of faults for the component within a time period.

4. The method of claim 3, wherein the product is a self-service terminal and the component of the product is a currency dispenser, a currency accepter, a keypad, a card reader, a scanner, a scale, or a printer.

5. The method of claim 4, wherein the self-service terminal is an automated teller machine.

6. The method of claim 1, wherein the workload data includes a number of transactions within a time period.

7. The method of claim 1, wherein the workload data includes a number of notes dispensed within a time period, a number of notes accepted during the time period, a number of cards read during the time period, and a number of checks accepted during a time period.

8. The method of claim 1, wherein determining the fault rate includes calculating a ratio of faults per component of the product to a number of transactions per component.

9. The method of claim 1, wherein determining when the product needs servicing includes, determining the product needs servicing when the fault rate is greater than or equal to a preset value and determining the product does not need servicing when the fault rate is lower than the preset value.

10. A system for targeting products for servicing, the system comprising:
a processor; and
a memory storing instructions that, when executed by the processor, cause the processor to perform operations comprising:
receiving fault data for a plurality of products, the fault data including a number of faults for each of the plurality of products within a time period,
receiving workload data for the plurality of products, the workload data including a workload for each of the plurality of products within the time period,
determining a fault rate for each of the plurality of products, the fault rate based on the fault data and the workload data, and
identifying a product from the plurality of products for servicing based on the fault rate for the product.

11. The system of claim 10, wherein receiving the fault data for the plurality of products includes receiving fault data from each of the plurality of products individually at regular intervals.

12. The system of claim 10, wherein the number of faults for each of the plurality of products includes a number of faults for individual components of each of the plurality of products during the time period.

13. The system of claim 10, wherein receiving the workload data for the plurality of products includes receiving a number of financial transactions for each of the plurality of products during the time period.

14. The system of claim 10, wherein the plurality of products is a plurality of automated teller machines.

15. The system of claim 10, wherein the workload for each of the plurality of products includes a number of transactions for each of the products within the time period.

16. The system of claim 10, wherein the workload for each of the plurality of products includes a number of notes dispensed within the time period, a number of notes received during the time period, a number of checks accepted during the time period, and a number of cards read during the time period.

17. A method for targeting products for servicing, the method comprising:
receiving, at a computing device comprising a processor, fault data for a plurality of products, the fault data including a number of faults for each of the plurality of products during a given time;
receiving, at the computing device, workload data for the plurality of products, the workload data including a number of work events during the given time;
determining, by the computing device, a fault rate for each of the plurality of products, the fault rate for each of the plurality of products based upon a corresponding number of faults and a corresponding number of work events for the given time; and
identifying a product from the plurality of products for servicing based on the fault rate for the product.

18. The method of claim 17, wherein the plurality of products are a plurality of self-service terminals.

19. The method of claim 17,
wherein the number of faults for each of the plurality of products includes a number of faults for a plurality of components of the plurality of products,
wherein determining the fault rate for each of the plurality of products includes determining a fault rate for each of the plurality of components based on a corresponding number of faults for each the plurality of components and a corresponding number of work events for each of the plurality of comments for the given time.

20. The method of claim 17, wherein identifying the product for servicing based on the fault rate for the product includes identifying the product for servicing when the fault rate for the product exceeds an average fault rate for the plurality of products by a preset value.
